(19) United States
(12) Patent Application Publication
(10) Pub. No.: US 2026/0316522 A1
(43) Pub. Date: Oct. 15, 2026

(54) SYSTEMS AND METHODS FOR ADJUSTING REFRIGERANT CAPACITY

(71) Applicant: Bergstrom, Inc., Rockford, IL (US)

(72) Inventors: Yevgeniy BEYGEL, Long Grove, IL (US); John BRACEY, Rockford, IL (US)

(21) Appl. No.: 19/647,724

(22) Filed: Apr. 14, 2026

Related U.S. Application Data
(60) Provisional application No. 63/789,357, filed on Apr. 15, 2025.

(51) Int. Cl. B60H 1/00; B60H 1/32

(52) U.S. Cl. CPC B60H 1/00885; B60H 1/00385; B60H 1/00735; B60H 1/3205

(57) ABSTRACT

Climate control systems are disclosed. A climate control system includes a compressor, a first heat exchanger (HX), a first expansion valve, and a second HX. The climate control system includes a second expansion valve fluidically coupled with the compressor between the first and second HXs. The climate control system includes a controller configured to obtain operational data from sensors and determine a thermal load based on the operational data. The controller is configured to in accordance with determination that the thermal load satisfies a first thermal load threshold, operate the second expansion valve in a first mode such that the climate control system has a first refrigerant capacity; and in accordance with determination that the thermal load satisfies a second thermal load threshold, operate the second expansion valve in a second mode such that the climate control system has a second refrigerant capacity less than the first refrigerant capacity.

### RELATED APPLICATION

This application claims priority to U.S. Provisional Application Serial No. 63/789,357, filed Apr. 15, 2025, entitled “Systems and Methods for Adjusting Refrigerant Capacity,” which is incorporated herein by reference.

### TECHNICAL FIELD

This relates generally to climate control systems, more specifically, climate control systems that can adjust system refrigerant capacity for continuous operation of high-capacity compressors.

### BACKGROUND

Thermal management demands of vehicles and machines has increased over time, which has led to a demand for high-capacity systems and/or high-capacity compressors. While high-capacity systems and/or high-capacity compressors can meet the increased cooling and heating capacity requirements, such systems and devices are not able to operate efficiently during low-load conditions.

As such, there is a need for systems and methods that can meet the increased thermal management demands and operate efficiently during various load conditions.

### SUMMARY

The systems and methods disclosed herein allow for continuous operation of a high-capacity systems. For example, the systems and methods disclosed herein allow high-capacity compressors to operate at minimal speed by providing proper lubrication to the high-capacity compressors at low-load conditions. In some embodiments, the systems and methods disclosed herein allow a refrigerant to bypass one or more heat exchangers in the system and return to the compressor via a controlled by-pass/expansion process. By providing a controlled bypass with expansion for the refrigerant (therefore reducing an amount of refrigerant flow through heat exchangers), the systems and methods disclosed herein reduce a minimal capacity of a high-displacement compressor, and enable efficient and controlled operation of the high-displacement compressor at low-load conditions.

In one aspect, a climate control system is disclosed. The climate control system includes a compressor fluidically coupled with a first heat exchanger, the first heat exchanger fluidically coupled with a first expansion valve, the first expansion valve fluidically coupled with a second heat exchanger, and the second heat exchanger fluidically coupled with the compressor. The climate control system also includes a second expansion valve fluidically coupled with the compressor between the first heat exchanger and the second heat exchanger. The second expansion valve is configured to operate as a bypass valve. The climate control system further includes one or more sensors and a controller. The controller is configured to obtain operational data from the one or more sensors and determine a thermal load based on the operational data. The controller is further configured to in accordance with determination that the thermal load satisfies a first thermal load threshold, operate the second expansion valve in a first mode such that the climate control system has a first refrigerant capacity; and in accordance with determination that the thermal load satisfies a second thermal load threshold, operate the second expansion valve in a second mode such that the climate control system has a second refrigerant capacity less than the first refrigerant capacity.

In another aspect, a method performed by a climate control system is disclosed. The climate control system includes a compressor fluidically coupled with a first heat exchanger, the first heat exchanger fluidically coupled with a first expansion valve, the first expansion valve fluidically coupled with a second heat exchanger, and the second heat exchanger fluidically coupled with the compressor. The climate control system also includes a second expansion valve fluidically coupled with the compressor between the first heat exchanger and the second heat exchanger, and one or more sensors. The method includes obtaining operational data from the one or more sensors and determining a thermal load based on the operational data. The method includes in accordance with determination that the thermal load satisfies a first thermal load threshold, operating the second expansion valve in a first mode such that the climate control system has a first refrigerant capacity. The method further includes in accordance with determination that the thermal load satisfies a second thermal load threshold, operating the second expansion valve in a second mode such that the climate control system has a second refrigerant capacity less than the first refrigerant capacity.

In yet another aspect, a non-transitory computer readable storage medium including instructions to be executed by a climate control system is disclosed. The climate control system includes a compressor fluidically coupled with a first heat exchanger, the first heat exchanger fluidically coupled with a first expansion valve, the first expansion valve fluidically coupled with a second heat exchanger, and the second heat exchanger fluidically coupled with the compressor. The climate control system also includes a second expansion valve fluidically coupled with the compressor between the first heat exchanger and the second heat exchanger, and one or more sensors. The instructions, when executed by the climate control system, cause the climate control system to obtain operational data from the one or more sensors and determine a thermal load based on the operational data. The instructions, when executed by the climate control system, also cause the climate control system to in accordance with determination that the thermal load satisfies a first thermal load threshold, operate the second expansion valve in a first mode such that the climate control system has a first refrigerant capacity. The instructions, when executed by the climate control system, further cause the climate control system to in accordance with determination that the thermal load satisfies a second thermal load threshold, operate the second expansion valve in a second mode such that the climate control system has a second refrigerant capacity less than the first refrigerant capacity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a block diagram of climate control system included in a vehicle, in accordance with some embodiments.

FIGS. 2A and 2B illustrate first and second operational modes of a bypass expansion device, in accordance with some embodiments.

FIG. 3 is a block diagram illustrating a representative controller 124 in accordance with some embodiments.

FIG. 4 depicts a method for controlling a climate control system in accordance with some embodiments.

FIG. 5 illustrates a flowchart of a method for reducing a minimal capacity of a compressor, in accordance with some embodiments.

Like reference numerals refer to corresponding parts throughout the several views of the drawings.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Many modifications and variations of this disclosure can be made without departing from its spirit and scope, as will be apparent to those skilled in the art. The specific embodiments described herein are offered by way of example only, and the disclosure is to be limited only by the terms of the appended claims, along with the full scope of equivalents to which such claims are entitled.

As used herein, a “refrigerant” is a fluid adapted to undergo phase transitions between liquid and gas during operation of a corresponding refrigerant system. For example, the refrigerant has a liquid-to-gas transition point below a target operating temperature of the refrigerant system. In various embodiments, the refrigerant can be classified according to different flammability classes, such as a class 1, class 2, class 2L, or class 3 refrigerants.

Some embodiments of the present disclosure are described in the context of air-conditioning systems. In some embodiments, the air-conditioning system includes, or is a component of, a heating, ventilation, and air-conditioning (HVAC) system. The embodiments of the present disclosure can be used in vehicles, buildings, rooms, or compartments. For example, embodiments of the present disclosure can be used in the context of an air-conditioning systems to cool different compartments or spaces of an over-the-road or off-road vehicle. It is to be appreciated that the term vehicle as used herein may refer to trucks, such as tractor-trailer trucks or semi-trailer trucks, the scope of the present teachings is not so limited. The present teachings are also applicable, without limitation, to electric vehicles, cars, vans, buses, trailers, boats, planes, and any other suitable vehicle. Similarly, the present teachings are also applicable, without limitation, to offices, homes, bedrooms, classrooms, and any other industrial, commercial, private and/or public buildings.

The systems and method disclosed herein reduce a minimal capacity of high-displacement (or high-capacity) compressor. By reducing a minimal capacity of a high-displacement compressor, the high-displacement compressor can operate efficiently and with controlled functionality at low-load conditions. The systems and method disclosed herein reduce an amount of refrigerant flow through heat exchangers through the use of a controlled by-pass with expansion for the refrigerant. The systems and method disclosed herein allow for continuous operation of a high-capacity compressor at low or minimal speeds, while also providing (proper) lubrication to the high-capacity compressor the at low load conditions. To allow for continuous operation of the high-capacity compressor at low or minimal speeds, the systems and method disclosed herein enable a refrigerant to bypass heat exchangers in the system and return discharge gas to a suction-side of the compressor via a controlled bypass/expansion process.

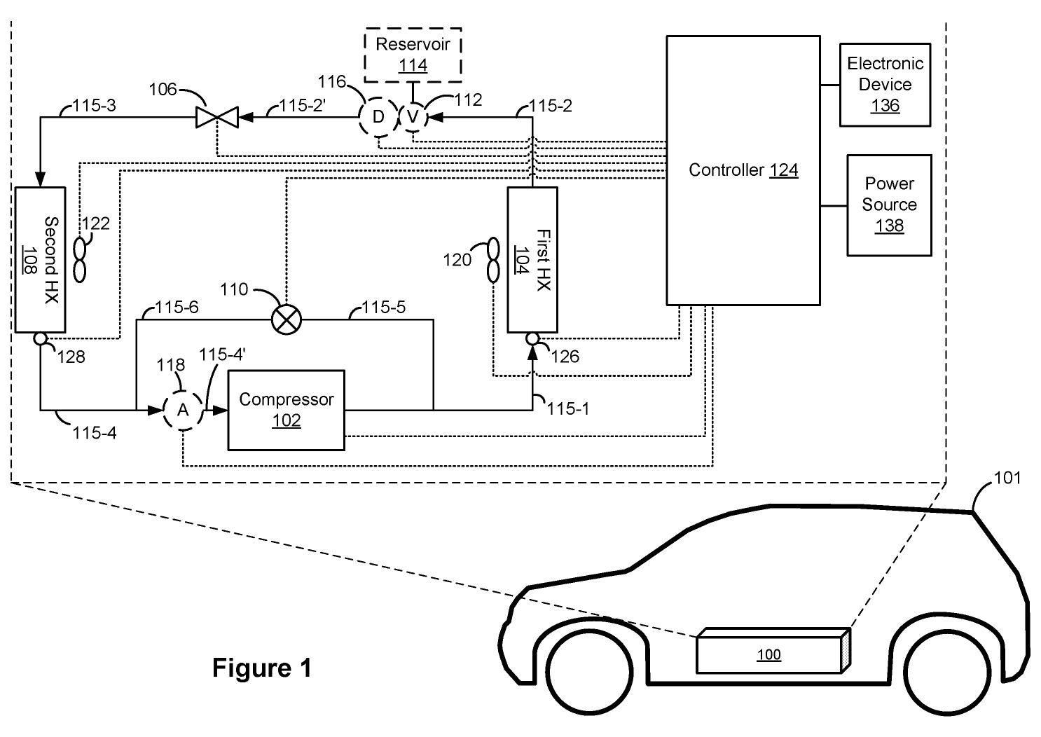

FIG. 1 is a block diagram of climate control system 100 included in a vehicle, in accordance with some embodiments. In some embodiments, the climate control system 100 is a high-capacity system. In some embodiments, the compressor is a high-capacity compressor and/or high-displacement compressor. The climate control system 100 is configured to meet increased thermal management demands of vehicles and/or other machines. For example, as shown in FIG. 1, the climate control system 100 is included in an electric vehicle 101.

The climate control system 100 (e.g., a heating, ventilation, and air conditioning (HVAC) system, an air-conditioning system, etc.) includes a (high-displacement or high-capacity) compressor 102 (e.g., any type of compressor including but not limited to a reciprocating compressor, rotary compressor, scrolling compressor, centrifugal compressor, screw compressor, heat pump, etc.), a first heat exchanger (HX) 104 (e.g., a condenser to absorb or remove heat), a first expansion device 106 (e.g., a thermal expansion valve and/or other metering devices), a second HX 108 (e.g., an evaporator to absorb heat from air in a compartment), and a second expansion device 110 (e.g., a thermal expansion valve and/or other metering devices). In some embodiments, the climate control system 100 includes a drier 116, reservoir 114, and/or accumulator 118. In some embodiments, the climate control system 100 includes one or more valves (e.g., valve 112, such as a flow control valve, a check valve, a pressure valve, etc.) and/or one or more air-moving devices (e.g., a first air-moving device 120 and a second air-moving device 122, such as a blower, a fan, etc.). The air-moving devices facilitate airflow within and/or outside of the climate control system 100 (e.g., to a thermally coupled compartment, cabin, room, building, etc.). In some embodiments, the climate control system 100 includes one or more heating elements (not shown) configured to change a temperature of air that passes through the one or more heating elements.

The climate control system 100 includes one or more sensors (e.g., a first sensor 126 and a second sensor 128) and a controller 124. The one or more sensors can include one or more temperature sensors, pressure sensors, CO2 sensors, thermometers, thermostats, humidity sensors, etc. The sensors obtain operational data from the climate control system 100 and/or thermally coupled devices, compartments, cabins, rooms buildings, etc. The operational data can include temperature, pressure, charge levels, air-moving device speeds, compressor speeds, compression rations, ambient temperature, room temperature, device temperature, current or power usage, humidity levels, CO2 levels, and/or other data that is used to adjust operation of the components within or thermally coupled to the climate control system 100. The controller 124 controls operation of the climate control system 100 as discussed below.

In some embodiments, the one or more sensors include a first temperature sensor disposed at or near an inlet of the compressor 102 and a second temperature sensor disposed at or near an outlet of the compressor 102. The first temperature sensor may measure a temperature of the refrigerant entering the compressor 102, and the second temperature sensor may measure a temperature of the refrigerant exiting the compressor 102. In some embodiments, the one or more sensors include a first pressure sensor disposed at or near the inlet of the compressor 102 and a second pressure sensor disposed at or near the outlet of the compressor 102.

In some embodiments, the one or more sensors include a temperature sensor and/or a pressure sensor disposed at or near the second expansion device 110. The temperature sensor and/or pressure sensor disposed at or near the second expansion device 110 may measure a temperature and/or pressure of the refrigerant flowing through the bypass circuit. In some embodiments, the one or more sensors include a temperature sensor disposed in the fifth refrigerant line 115-5 and/or the sixth refrigerant line 115-6.

In some embodiments, the one or more sensors include a compartment temperature sensor disposed in a compartment thermally coupled with the climate control system 100. The compartment temperature sensor may be a thermostat configured to measure a temperature of air in the compartment. In some embodiments, the one or more sensors include an ambient temperature sensor disposed outside of the compartment to measure an ambient temperature.

The different components of the climate control system 100 are fluidically coupled together and/or disposed proximate to one or more components. For example, as shown by the climate control system 100, a first refrigerant line 115-1 fluidically couples the compressor 102 and the first HX 104; a second refrigerant line 115-2 fluidically couples the first HX 102 and a first expansion device 106; a third refrigerant line 115-3 fluidically couples the first expansion device 106 and the second HX 108; a fourth refrigerant line 115-4 fluidically couples the second HX 108 and the compressor 102; a fifth refrigerant line 115-5 fluidically couples an outlet of the compressor 102 and the second expansion device 110; and a sixth refrigerant line 115-6 fluidically couples the second expansion device 110 and an inlet of the compressor 102. In some embodiments, an additional second refrigerant line 115-2’ fluidically couples one or more optional components, such as the drier 116, the valve 112, and/or the reservoir 114, between the first HX 104 and the first expansion device 106. Similarly, in some embodiments, an additional fourth refrigerant line 115-4’ fluidically couples the (optional) accumulator 118 between the second HX 108 and the compressor 102. The first sensor 126 can be disposed adjacent to the first HX 104 and the second sensor 128 can be disposed adjacent to the second HX 108. In some embodiments, the first air-moving device 120 is disposed proximate and/or adjacent to the first HX 104 and the second air-moving device 122 is disposed proximate and/or adjacent to the second HX 108. Although not shown, one or more sensors can be included on devices, compartments, cabins, rooms buildings, etc. thermally coupled with the climate control system 100.

The (optional) drier 116 temporarily stores a (two-phase) refrigerant (or fluid) and/or absorbs moisture, debris, or other undesirable substances from a received refrigerant. The drier 116 can be disposed between the first HX 104 and the first expansion device 106. In some embodiments, the drier 116 is fluidically coupled with a reservoir 114 via the valve 112. The valve 112 can be operated by the controller 124 to increase a charge level of the refrigerant (e.g., an amount of refrigerant) in accordance with a determination that the charge level is below a predetermined level. The drier 112 can include one or more sensors communicatively coupled with the controller 124 that provide additional operational data to the controller 124.

In some embodiments, the fifth refrigerant line 115-5 branches from the first refrigerant line 115-1 at a location downstream of a discharge port of the compressor 102 and upstream of the first HX 104. The sixth refrigerant line 115-6 may join the fourth refrigerant line 115-4 at a location downstream of the second HX 108 and upstream of a suction port of the compressor 102. In some embodiments, the fifth refrigerant line 115-5 and the sixth refrigerant line 115-6 form a bypass circuit that is parallel to the main refrigerant circuit comprising the first HX 104, the first expansion device 106, and the second HX 108. The bypass circuit may be configured to divert a portion of the refrigerant flow from the main refrigerant circuit when the second expansion device 110 is in an open or partially open position.

In some embodiments, the refrigerant flows in a first direction from the compressor 102 through the first refrigerant line 115-1 to the first HX 104, and in a second direction from the second HX 108 through the fourth refrigerant line 115-4 back to the compressor 102. The bypass flow through the fifth refrigerant line 115-5 and the sixth refrigerant line 115-6 may be in the same general direction as the main refrigerant flow, from the discharge side of the compressor 102 to the suction side of the compressor 102.

In some embodiments, the fifth refrigerant line 115-5 connects to the first refrigerant line 115-1 at a junction point located between the discharge port of the compressor 102 and an inlet of the first HX 104. The junction point may be upstream of any check valves disposed in the first refrigerant line 115-1. In some embodiments, the sixth refrigerant line 115-6 connects to the fourth refrigerant line 115-4 at a junction point located between an outlet of the second HX 108 and the suction port of the compressor 102. The junction point of the sixth refrigerant line 115-6 may be downstream of the accumulator 118, if present, or upstream of the accumulator 118. In some embodiments, the junction point of the sixth refrigerant line 115-6 is configured such that the medium temperature return bypass gas mixes with the low temperature return gas before entering the compressor 102.

The (optional) accumulator 118 restricts (liquid) refrigerant (or fluid) from entering the compressor 102. The accumulator 118 can temporarily store an excess liquid refrigerant (or fluid) to prevent damage to the compressor 102. In some embodiments, the accumulator 118 is fluidically coupled with another valve (e.g., another flow control valve, not shown). The other valve can be operated by the controller 124 to selectively restrict or permit flow of the refrigerant (or fluid) to the compressor 102. The accumulator 118 can also include one or more sensors communicatively coupled with the controller 118 that provide additional operational data to the controller 118. Although not show, in some embodiments, a reservoir can be fluidically coupled to the accumulator 118 via another valve such that a charge level of the refrigerant (or fluid) can be adjusted.

The controller 124 is communicatively coupled with at least the compressor 102, the first HX 104 (and/or first air-moving device 120), the first expansion device 106, the second HX 106 (and/or second air-moving device 122), the one or more sensors, and/or the second expansion device 110. The controller 124 is configured to control one or more communicatively coupled components to adjust operation of the climate control system 100. In some embodiments, the controller 124 adjusts operation of one or more components based on the operational data obtained by the sensors and/or operational information provided by one or more communicatively coupled components (e.g., compressor on, first air-moving device on, etc.).

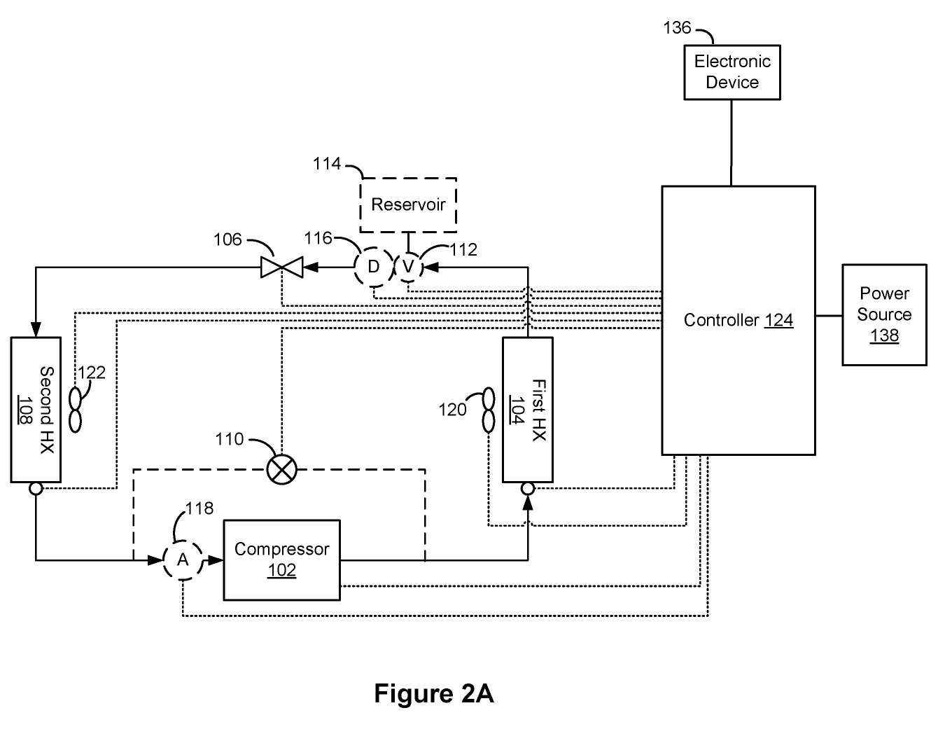

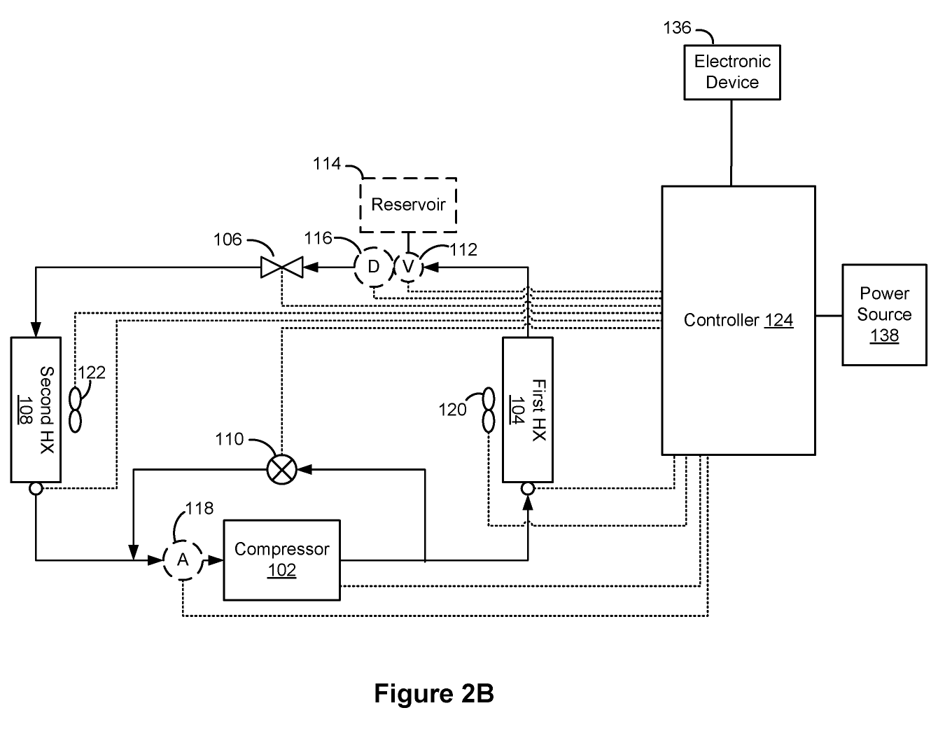

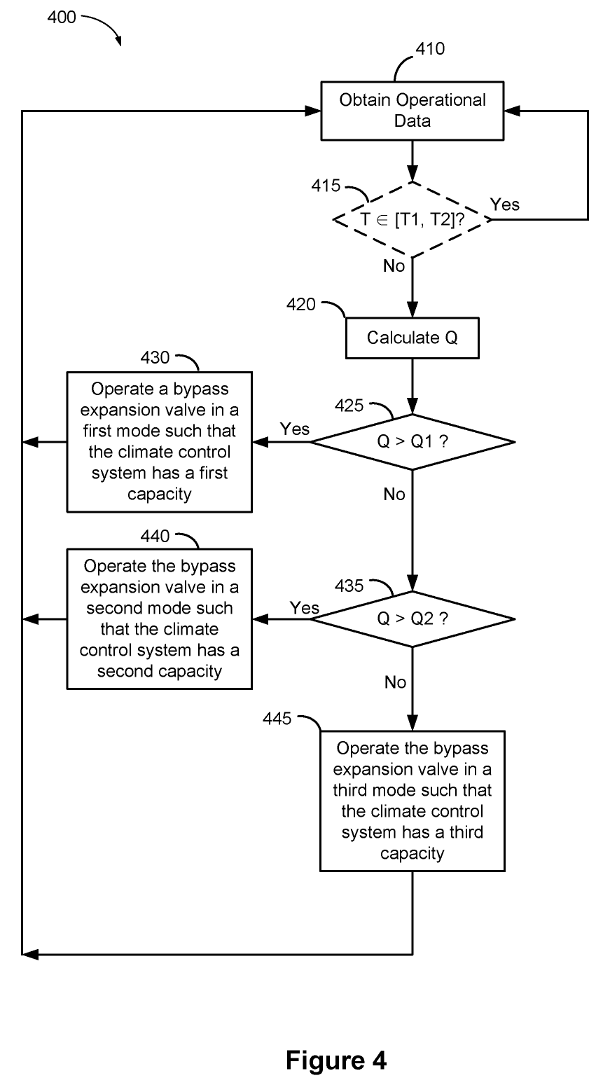

For example, the controller 124 is configured to control an operational mode of the second expansion device 110 to adjust a refrigerant capacity of the climate control system 100. In some moments, the controller 124 adjusts an operational mode of the second expansion device 110 based on a thermal load of the climate control system 100. For example, in accordance with determination that a thermal load satisfies a first thermal load threshold, the controller 124 operates the second expansion device 110 in a first mode such that the climate control system 100 has a first refrigerant capacity. Alternatively, in accordance with determination that a thermal load satisfies a second thermal load threshold, the controller 124 operates the second expansion device 110 in a second mode such that the climate control system 100 has a second refrigerant capacity less than the first refrigerant capacity. Additional information on operation of the second expansion device 110 is provided below in reference to FIGS. 2A, 2B, and 4.

The controller 124 is configured to determine a thermal load based on the operational data. For example, the controller 124 can determine a thermal load, at least partially, based on a difference between a desired temperature (e.g., a user provided temperature) and a measured temperature of a compartment. In some embodiments, the controller 124 is configured to determine a thermal load based, at least partially, on a difference between a desired temperature range and a measured temperature of a compartment. For example, the controller 124 can calculate a thermal load based on a mid-point of a desired temperature range (e.g., a minimum to maximum temperature) and/or an upper boundary of the desired temperature range.

In some embodiments, the controller 124 calculates the thermal load based on a formula that includes a difference between a desired temperature and a measured temperature of a compartment. For example, the thermal load may be calculated as Q = k × (T_measured − T_desired), where Q is the thermal load, k is a constant, T_measured is the measured temperature of the compartment, and T_desired is the desired temperature. In some embodiments, the constant k is based on characteristics of the compartment, such as a volume of the compartment, an insulation level of the compartment, or a heat transfer coefficient of the compartment.

In some embodiments, the controller 124 calculates the thermal load based on a weighted combination of multiple factors. For example, the thermal load may be calculated based on a weighted combination of a temperature difference, an ambient temperature, a humidity level, a solar load, and/or other factors. In some embodiments, the controller 124 assigns weighting factors to each factor based on a relative importance of each factor to the thermal load.

In some embodiments, the controller 124 combines sensor inputs from multiple sensors to calculate the thermal load. For example, the controller 124 may average temperature readings from multiple temperature sensors disposed in different locations of a compartment. In some embodiments, the controller 124 applies a filtering algorithm (e.g., a moving average filter, a Kalman filter, or other suitable filter) to the sensor inputs to reduce noise and improve accuracy of the thermal load calculation.

The controller 124 can use operational data to adjust a speed of the compressor 102, the first air-moving device 120, and/or the second air-moving device 122. Additionally, the controller 124 can be configured to identify one or more errors in the climate control system 100 based on the operational data and/or operational information. For example, the climate control system 100 can calculate a compression ratio of the compressor 102 to determine whether a blockage is present and/or a location of the blockage (e.g., based on various factors such an abnormal sub-cooling level, abnormal super-cooling, etc.). In some embodiments, the controller 124 operates one or more valves (e.g., the valve 112) to inject refrigerant from the (refrigerant) reservoir 114 into the climate control system 100 when the refrigerant charge level is below a predetermined refrigerant charge level. In some embodiments, the controller 124 selectively operates the valve 112 to allow flow of a refrigerant from the reservoir 114 to the climate control system 100. In some embodiments, one or more valves selectively restrict or permit flow of the refrigerant to the compressor 102.

In some embodiments, the climate control system 100 can include a power source 138 for powering one or more components, such as the first air-moving device 120, the second air-moving device 122, the compressor 102, the first HX 104, the second HX 108, and the like. In some embodiments, the power source 138 includes a solar cell, an electrical battery, an alternator, or the like. In some embodiments, the power source 138 is belt driven from an internal combustion engine of a vehicle.

In some embodiments, the controller 124 is electrically or wirelessly coupled to an electronic device 136 including but not limited to a display, a receiver, a smartphone or a computer. The controller 124 can provide one or more notifications or signals to be presented or used by the electronic device. For example, the notifications can include audio notifications, such as a beep, alarm, or tune, or visual notifications, such a text or graphic displayed on a screen. The signals include but are not limited to data (e.g., a cooling level, a super-heating level and a refrigerant charge level), warning signals (e.g., a refrigerant charge level is below a predetermined refrigerant charge level), maintenance request or the like. In some embodiments, the controller 124 is configured to receive one or more instructions from the electronic device for adjusting operation of the climate control system 100. For example, the controller 124 can receive one or more instructions for adjusting a temperature of a compartment, defining a desired temperature, defining a desired temperature threshold, adjusting an air-mover speed, adjusting a compressor speed, adjusting a pump speed, etc.

FIGS. 2A and 2B illustrate first and second operational modes of a bypass expansion device, in accordance with some embodiments. FIG. 2A shows the climate control system 100 operating the second expansion device 110 in a first mode. In particular, the controller 124 provides one or more signals for operating the second expansion device 110 in the first mode. In some embodiments, the second expansion device 110 is a closed position. Additionally, while the second expansion device 110 is in the first mode, the climate control system 100 is a first capacity. The first capacity can be the normal or initial capacity of the climate control system 100.

While the second expansion device 110 operates in the first mode, the compressor 102 compresses a refrigerant and causes a compressed refrigerant (e.g., a high temperature discharge gas) to flow towards the first HX 104. The first HX 104 transfers (e.g., dissipates) heat from the compressed refrigerant and causes the refrigerant to flow through the first HX 104 towards the first expansion device 106. In some embodiments, the first HX 104 condenses the compressed refrigerant. The first expansion device 106 receives the refrigerant from the first HX 104 and removes pressure from the refrigerant such that the refrigerant can expand or change states. The refrigerant flows through the first expansion device 106 towards the second HX 108. The second HX 108 absorbs heat from the refrigerant before returning the refrigerant to the compressor 102. The refrigerant returned to the compressor 102 is a low-temperature return gas.

In other words, while the second expansion device 110 operates in the first mode, the refrigerant flows through the climate control system 100 without being re-routed or the HXs being bypassed. In some embodiments, the second expansion device 110 is operated in the first mode when a first thermal load threshold is satisfied. In some embodiments, the first thermal load threshold is a high-load condition. In some embodiments, while the second expansion device 110 operates in the first mode, the (high-capacity) compressor 102 is configured to operate at a maximum speed.

Turning to FIG. 2B, the climate control system 100 is shown operating the second expansion device 110 in a second mode. In particular, the controller 124 provides one or more signals for operating the second expansion device 110 in the second mode. In some embodiments, the second expansion device 110 is an open position. Additionally, while the second expansion device 110 is in the second mode, the climate control system 100 is a second capacity, less than the first capacity. The second capacity can be a reduced capacity of the climate control system 100.

While the second expansion device 110 operates in the second mode, the compressor 102 compresses a refrigerant and causes a compressed refrigerant (e.g., a high temperature discharge gas) to flow towards the first HX 104 and the second expansion device 110. A portion of the compressed refrigerant is directed towards the first HX 104 flows through the climate control system 100 as described above in reference to FIG. 2A. Another portion of the compressed refrigerant (e.g., the high temperature discharge gas) is directed toward the second expansion device 110 (e.g., a portion of the compressed refrigerant is redirected from the first HX 104 to the second expansion device 110). The second expansion device 110 receives the portion of the compressed refrigerant from the compressor 102 and removes pressure from the compressed refrigerant such that the refrigerant can expand or change of state. The second expansion device 110 also transfers (e.g., dissipates) heat from the compressed refrigerant such that the refrigerant returns to the compressor a lower temperature (e.g., a medium temperature return bypass gas). In some embodiments, the medium temperature return bypass gas is combined or mixed with a low temperature return gas provided by the second HX 108 before being returned to the compressor 102.

By operating the second expansion device 110 in the second mode, the climate control system 100 reduces a capacity of the system by reducing an amount of refrigerant flow through the first HX 104 and the second HX 108. Because operating the second expansion device 110 in the second mode causes i) a refrigerant to bypass the first HX 104 and the second HX 108 in the climate control system 100 and ii) return discharge gas to a suction-side of the compressor 102, the climate control system 100 allows for continuous operation of the (high-capacity) compressor 102 at minimal speed. In other words, operating the second expansion device 110 in the second mode allows for (proper) lubrication of the (high-capacity) compressor 102 at low load conditions such that the compressor 102 is able to operate efficiently and/or without being damaged.

In some embodiments, the compressor 102 includes an oil sump configured to store lubricating oil. The lubricating oil circulates with the refrigerant through the climate control system 100 to lubricate moving parts of the compressor 102. In some embodiments, the lubricating oil is entrained in the refrigerant and flows through the refrigerant lines with the refrigerant.

In some embodiments, the bypass flow through the second expansion device 110 maintains a minimum refrigerant flow rate through the compressor 102 to ensure adequate oil circulation. The minimum refrigerant flow rate may be based on a minimum oil return rate required to lubricate the compressor 102.

In some embodiments, the bypass flow through the second expansion device 110 prevents oil from accumulating in the first HX 104 and/or the second HX 108 during low load conditions. By diverting a portion of the refrigerant flow through the bypass circuit, the climate control system 100 maintains sufficient refrigerant velocity in the main refrigerant circuit to return oil to the compressor 102. In some embodiments, the controller 124 adjusts the valve position of the second expansion device 110 to maintain a minimum refrigerant velocity in the main refrigerant circuit.

In some embodiments, the second expansion device 110 is operated in the second mode when a second thermal load threshold is satisfied. In some embodiments, the second thermal load threshold is a low-load condition. In some embodiments, while the second expansion device 110 operates in the second mode, the (high-capacity) compressor 102 is configured to operate at a low or non-maximum speed.

In some embodiments, the second expansion device 110 is an electronically controlled expansion valve. The controller 124 may provide one or more control signals to the second expansion device 110 to adjust a valve position of the second expansion device 110. In some embodiments, the second expansion device 110 is a thermally actuated expansion valve or a mechanically operated expansion valve.

In some embodiments, the second expansion device 110 is configured to operate in a plurality of positions between a fully closed position and a fully open position. For example, the second expansion device 110 may operate at 0% open (fully closed), 25% open, 50% open, 75% open, or 100% open (fully open). In some embodiments, the second expansion device 110 is configured to operate at any position within a continuous range between the fully closed position and the fully open position.

In some embodiments, the controller 124 transitions the second expansion device 110 between modes gradually. For example, the controller 124 may incrementally adjust the valve position of the second expansion device 110 over a period of time to transition from the first mode to the second mode. In some embodiments, the controller 124 transitions the second expansion device 110 between modes in a stepwise manner.

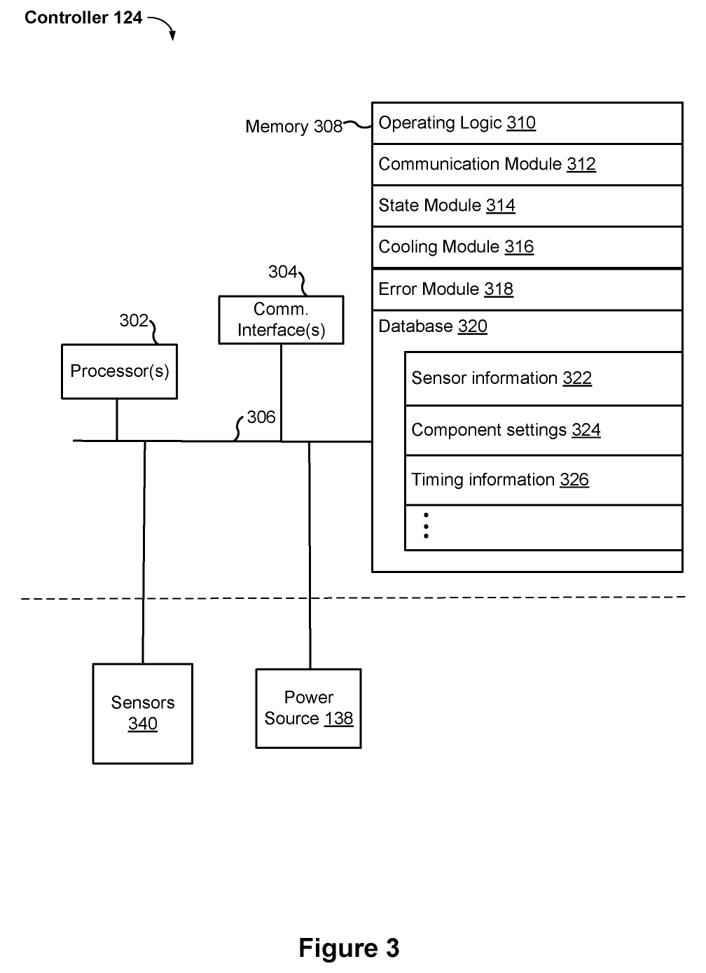

FIG. 3 is a block diagram illustrating a representative controller 124 in accordance with some embodiments. In some embodiments, the controller 124 includes one or more processing units (e.g., CPUs, ASICs, FPGAs, microprocessors, and the like) 302, one or more communication interfaces 304, memory 308, and one or more communication buses 306 for interconnecting these components (sometimes called a chipset). In some embodiments, the controller 124 includes one or more input devices, such as one or more buttons for receiving input. In some embodiments, the controller 124 includes one or more output devices, such as one or more indicator lights, a sound card, a speaker, a small display for displaying textual information and error codes, etc. In some embodiments, the controller 124 includes a location detection device, such as a GPS (global positioning satellite) or other geo-location receiver, for determining the location of the controller 124. The controller 124 is coupled to one or more sensors 340 (e.g., first and second sensors 126 and 128; FIG. 1) and a power source 138, as shown and described above in reference to FIG. 1.

Communication interfaces 304 include, for example, hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

Memory 308 includes high-speed random-access memory, such as DRAM, SRAM, DDR SRAM, or other random-access solid-state memory devices; and, optionally, includes non-volatile memory, such as one or more magnetic disk storage devices, one or more optical disk storage devices, one or more flash memory devices, or one or more other non-volatile solid state storage devices. Memory 308, or alternatively the non-volatile memory within memory 308, includes a non-transitory computer-readable storage medium. In some embodiments, memory 308, or the non-transitory computer readable storage medium of memory 308, stores programs, modules, data structures, or a subset or superset thereof. Example programs, modules, and/or data structures include operating logic 310, a communication module 312, a state module 314, a cooling module 316, an error module 318, and database 320.

The operating logic 310 includes procedures for handling various system services and for performing hardware dependent tasks. The communication module 312 is used to connect to and/or communicate with other network devices connected to one or more networks via the one or more communication interfaces 304 (e.g., wired or wirelessly connected). The state module 314 determine an operating state of the system (e.g., of air-conditioning system 100, FIG. 1) and/or sets/adjusts the operating state of the system. The cooling module 316 manages cooling operations of the system (e.g., temperature settings, fan speeds, power settings, etc.). The error module 318 determines whether one or more error conditions are present and/or conveys the one or more error conditions to a user of the system and/or initiates remedial actions in response to the one or more error conditions. The database 320, includes, but is not limited to, sensor information 322 for storing and managing data received, detected, and/or transmitted by one or more sensors 340 of the system; component settings 324 for storing and managing operational settings for one or more components of the system (e.g., first HX 104, compressor 102, air-mover devices, and/or second HX 106); and timing information 326 for storing and managing timing information related to operation and/or testing of the system.

Each of the above identified elements (e.g., modules stored in memory 308 of controller 124) corresponds to a set of instructions for performing a function described herein. The above identified modules or programs (i.e., sets of instructions) need not be implemented as separate software programs, procedures, or modules, and thus various subsets of these modules may be combined or otherwise rearranged in various embodiments. In some embodiments, memory 308, optionally, stores a subset of the modules and data structures identified above. Furthermore, memory 308, optionally, stores additional modules and data structures not described above. For example, memory 308 optionally stores a heating module (not shown) for managing heating operations of the system.

In some embodiments, the controller 124 determines when to transition between modes based on one or more control algorithms. The control algorithms may include proportional-integral-derivative (PID) control, fuzzy logic control, model predictive control, or other suitable control algorithms. In some embodiments, the controller 124 calculates a thermal load based on a weighted combination of operational data from the one or more sensors.

In some embodiments, the controller 124 implements hysteresis or deadband values to prevent rapid cycling between modes. For example, the controller 124 may require the thermal load to exceed the first thermal load threshold by a predetermined margin before transitioning from the second mode to the first mode. Similarly, the controller 124 may require the thermal load to fall below the second thermal load threshold by a predetermined margin before transitioning from the first mode to the second mode. In some embodiments, the predetermined margin is a percentage of the thermal load threshold (e.g., 5%, 10%, or 15%) or a fixed value.

In some embodiments, the controller 124 implements a time delay between mode transitions. For example, the controller 124 may require the thermal load to satisfy a thermal load threshold for a predetermined period of time (e.g., 30 seconds, 1 minute, or 5 minutes) before transitioning between modes. The time delay may prevent rapid cycling between modes due to transient fluctuations in the thermal load.

FIG. 4 depicts a method (400) for controlling a climate control system in accordance with some embodiments. In some embodiments, the method (400) is performed by a climate control system, such as the climate control system 100 (FIG. 1), or one or more components of the climate control system, such as controller 124. In some embodiments, the method (400) is performed by a device or controller coupled to the climate control system. Thus, in some embodiments, the operations of the method (400) described herein are entirely interchangeable, and respective operations of the method (400) are performed by any of the aforementioned devices, systems, or combination of devices and/or systems. In some embodiments, the method (400) is governed by instructions that are stored in a non-transitory computer-readable storage medium and that are executed by one or more processors of the climate control system, such as the one or more processors of controller 124. For convenience, the method (400) is described below as being performed by a system, such as the climate control system 100.

In some embodiments, the climate control system, such as the climate control system 100, is installed in a vehicle for heating and cooling a compartment of the vehicle. The vehicle can be an electric vehicle requiring a high-capacity system and/or high-capacity compressor. Alternatively, in some embodiments, the climate control system is part of a machine or building requiring a high-capacity system and/or high-capacity compressor. In some embodiments, the climate control system includes a bypass expansion device (e.g., second expansion device 110; FIG. 1) fluidically coupled with a compressor 102 between first and second HXs 104 and 108, and a controller 124.

The system obtains (410) obtains operational data from one or more sensors. In some embodiments, the system obtains (410) the operational data at a predefined interval (e.g., every 10 seconds, 30 seconds, or 1 minute). The operational data can include temperature for a thermally coupled compartment (T). In some embodiments, the system determines (415) whether the temperature in the compartment is within a desired temperature range ([T1, T2]), where T2 is equal to or greater than T1. In some embodiments, the desired temperature range ([T1, T2]) is based on a desired temperature obtained from a user (e.g., is +/−1, 2, or 3 degrees from the desired temperature). In some embodiments, the system determines whether the temperature in the compartment is below T1, within [T1, T2] (either inclusively or exclusively), or above T2. The operational data can include other data described above in reference to FIG. 1. In accordance with a determination that the temperature in the compartment is within the desired temperature range (“Yes” at operation 415), the system returns to operation (410).

In accordance with a determination that the temperature in the compartment is above the desired temperature range (“No” at operation 415), the system calculates (420) a thermal load of the compartment (Q) based at least partially on the desired temperature range and the measured temperature. In some embodiments, the system calculates a thermal load (e.g., of the compartment) based at least partially on a difference between the desired temperature and the measured temperature. In some embodiments, the system calculates a thermal load (e.g., of the compartment) based at least partially on a difference between the desired temperature range and the measured temperature. For example, the controller calculates a thermal load based on a mid-point of the desired temperature range and/or an upper boundary of the desired temperature range. In some embodiments, the system calculates (420) a thermal load without a desired temperature and based on the operational data.

The system determines (425) whether the thermal load (Q) exceeds (or meets or exceeds) a first predetermined thermal load threshold (Q1). In some embodiments, the first predetermined thermal load threshold is a high-load condition. In accordance with a determination that the thermal load exceeds (or meets or exceeds) the first predetermined thermal load threshold (“Yes” at operation 425), the system operates (430) the bypass expansion valve in a first mode such that the climate control system has a first capacity. In some embodiments, the first mode is a closed position of the bypass expansion valve, and the first capacity is a high (refrigerant) capacity. In some embodiment, in accordance with a determination that the thermal load exceeds (or meets or exceeds) the first predetermined thermal load threshold (“Yes” at operation 425), the system operates the compressor (e.g., a high-capacity compressor) at a first speed. In some embodiments, the first speed is a maximum speed. The system, after operating the bypass expansion valve in the first mode, returns to operation (410). Additional information on the bypass expansion valve operating in the closed position is provided above in reference to FIG. 2A.

In accordance with a determination that the thermal load does not exceed the first predetermined thermal load threshold (“No” at operation 425), the system determines (435) whether the thermal load (Q) exceeds (or meets or exceeds) a second predetermined thermal load threshold (Q2). In some embodiments, the second predetermined thermal load threshold is an intermediary-load condition less that the first predetermined thermal load threshold (or high-load condition). In accordance with a determination that the thermal load exceeds (or meets or exceeds) the second predetermined thermal load threshold (“Yes” at operation 435), the system operates (440) the bypass expansion valve in a second mode such that the climate control system has a second capacity. In some embodiments, the second mode is a partially open position of the bypass expansion valve, and the second capacity is an intermediary (refrigerant) capacity. The intermediary (refrigerant) capacity being less than the first capacity (or the high (refrigerant) capacity). In some embodiment, in accordance with a determination that the thermal load exceeds (or meets or exceeds) the second predetermined thermal load threshold (“Yes” at operation 435), the system operates the compressor (e.g., the high-capacity compressor) at a second speed. In some embodiments, the second speed is an intermediary speed (less than the maximum speed). The system, after operating the bypass expansion valve in the second mode, returns to operation (410).

In accordance with a determination that the thermal load does not exceed the second predetermined thermal load threshold (“No” at operation 435), the system operates (445) the bypass expansion valve in a third mode such that the climate control system has a third capacity. In some embodiments, the third mode is an open position of the bypass expansion valve, and the third capacity is a reduced or low (refrigerant) capacity. The reduced or low (refrigerant) capacity being less than the second capacity (or the intermediary (refrigerant) capacity). In some embodiment, in accordance with a determination that the thermal load does not exceed (or meets or exceeds) the second predetermined thermal load threshold (“No” at operation 435), the system operates the compressor (e.g., the high-capacity compressor) at a third speed. In some embodiments, the third speed is a low speed (less than or equal to the intermediary speed). The system, after operating the bypass expansion valve in the third mode, returns to operation (410). Additional information on the bypass expansion valve operating in the open position is provided above in reference to FIG. 2B.

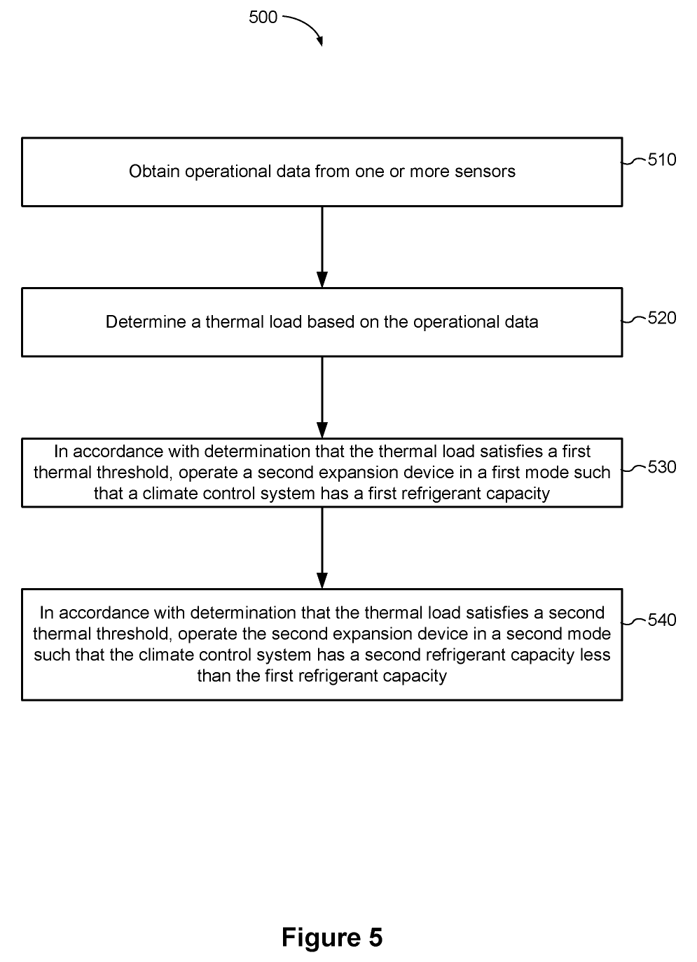

FIG. 5 illustrates a flowchart of a method (500) for reducing a minimal capacity of a (high displacement) compressor, in accordance with some embodiments. In some embodiments, the method (500) is performed by a climate control system described above in reference to FIGS. 1A-2B. In some embodiments, the method (500) is performed by a device or controller coupled to the climate control system. Thus, in some embodiments, the operations of the method (500) described herein are entirely interchangeable, and respective operations of the method (500) are performed by any of the aforementioned devices, systems, or combination of devices and/or systems. In some embodiments, the method (500) is governed by instructions that are stored in a non-transitory computer-readable storage medium and that are executed by one or more processors of the climate control system, such as the one or more processors of controller 124. For convenience, the method (500) is described below as being performed by a system, such as the climate control system 100.

(A1) The method (500) includes obtaining (510) operational data from one or more sensors and determining (520) a thermal load based on the operational data. The method (500) includes in accordance with determination that the thermal load satisfies a first thermal threshold, operating (530) a second expansion device in a first mode such that a climate control system has a first refrigerant capacity. The method (500) further includes in accordance with determination that the thermal load satisfies a second thermal threshold, operating the second expansion device in a second mode such that the climate control system has a second refrigerant capacity less than the first refrigerant capacity. For example, as described above in reference to FIGS. 2A and 2B, the second expansion device 110 can be closed such that the climate control system 100 has a high capacity, and the second expansion device 110 can be opened such that the climate control system 100 has a low or reduced capacity.

(A2) In some embodiments of A1, the second thermal load threshold is lower than the first thermal load threshold.

(A3) In some embodiments of any one of A1-A2, the second expansion device, when operating in the second mode, expands a refrigerant receive from the compressor before returning the refrigerant to the compressor. For example, as described above in reference to FIG. 2B, the second expansion device 110 is configured to receive a high temperature discharge gas from a (high- displacement or high-capacity) compressor 102, expand the high temperature discharge gas, and return a medium temperature return bypass gas to the compressor 102.

(A4) In some embodiments of any one of A1-A3, the method 500 further includes in accordance with determination that the thermal load satisfies a third thermal load threshold, operating the second expansion device in a third mode such that the climate control system has a third refrigerant capacity distinct from the first refrigerant capacity and the second refrigerant capacity. For example, the second expansion device can be operated in an intermediary mode that partially opens the second expansion device.

(A5) In some embodiments of any one of A1-A4, the method 500 further includes in accordance with determination that the thermal load satisfies the first thermal load threshold, operating the compressor at a first operating speed, and in accordance with determination that the thermal load satisfies the second thermal load threshold, operating the compressor at a second operating speed. As described above, by reducing a capacity of the climate control system, a high-capacity compressor can be operated a low speed during low-load condition.

(A6) In some embodiments of A5, the second operating speed is less than the first operating speed.

(A7) In some embodiments of any one of A1-A6, the climate control system includes a first air-moving device and a second air-moving device, and the method 500 further includes adjusting operation of a first air-moving device and/or a second air-moving device based on the operational data:

(A8) In some embodiments of any one of A1-A7, the climate control system is a high-capacity system and/or the compressor is a high-capacity compressor.

(A9) In some embodiments of any one of A1-A8, the operating data includes one or more of a refrigerant temperature, a refrigerant pressure, a compressor speed, a compression ratio, an air-moving device speed, a refrigerant charge level, an ambient temperature, and a compartment temperature.

(A10) In some embodiments of any one of A1-A9, the method 500 includes determining a refrigerant charge level based on the operational data; in accordance with determination that the refrigerant charge level satisfies a first refrigerant charge level threshold, operating the second expansion device in the first mode; and in accordance with determination that the refrigerant charge level satisfies a second refrigerant charge level, operating the second expansion device in the second mode.

(A11) In some embodiments of any one of A1-A10, the climate control system includes a receiver/drier disposed between a first heat exchanger and a second heat exchanger, the receiver/drier configured to temporarily store a refrigerant, and absorb moisture from the refrigerant.

(A12) In some embodiments of any one of A1-A11, the climate control system further includes an accumulator disposed between the second heat exchanger and the compressor, the accumulator configured to temporarily store a refrigerant, and convert a mixed refrigerant into a gas refrigerant.

(A13) In some embodiments of any one of A1-A12, the method 500 further includes receiving a desired temperature from an electronic device communicatively coupled with a controller, and determination of the thermal load is further based on the desired temperature.

(A14) In some embodiments of any one of A1-A13, the climate control system is included in an electric vehicle.

(B1) In accordance with some embodiments, a non-transitory computer readable storage medium includes instructions that, when executed by a climate control system in accordance with any of A1-A14, cause the climate control system to perform operations of A1-A14.

(C1) In accordance with some embodiments, a climate control system in accordance with any of A1-A14 configured to perform operations of A1-A14.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

It will also be understood that, although the terms first, second, etc. are, in some instances, used herein to describe various elements, these elements should not be limited by these terms. These terms are only used to distinguish one element from another. For example, a first condition could be termed a second condition, and, similarly, a second condition could be termed a first condition, without departing from the scope of the various described embodiments. The first condition and the second condition are both conditions, but they are not the same condition.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A climate control system, comprising:
a compressor fluidically coupled with a first heat exchanger;
a first expansion device fluidically coupled with the first heat exchanger;
a second heat exchanger fluidically coupled with the first expansion device and the compressor;
a second expansion device fluidically coupled with the compressor between the first heat exchanger and the second heat exchanger, wherein the second expansion device operates as a bypass valve;
one or more sensors; and
a controller configured to:
obtain operational data from the one or more sensors,
determine a thermal load based on the operational data,
in accordance with determination that the thermal load satisfies a first thermal load threshold, operate the second expansion device in a first mode such that the climate control system has a first refrigerant capacity, and
in accordance with determination that the thermal load satisfies a second thermal load threshold, operate the second expansion device in a second mode such that the climate control system has a second refrigerant capacity less than the first refrigerant capacity.

2. The climate control system of claim 1, wherein the second thermal load threshold is lower than the first thermal load threshold.

3. The climate control system of claim 1, wherein the second expansion device, when operating in the second mode, expands a refrigerant receive from the compressor before returning the refrigerant to the compressor.

4. The climate control system of claim 1, wherein the controller is further configured to:
in accordance with determination that the thermal load satisfies a third thermal load threshold, operate the second expansion device in a third mode such that the climate control system has a third refrigerant capacity distinct from the first refrigerant capacity and the second refrigerant capacity.

5. The climate control system of claim 1, wherein the controller is further configured to:
in accordance with determination that the thermal load satisfies the first thermal load threshold, operate the compressor at a first operating speed, and
in accordance with determination that the thermal load satisfies the second thermal load threshold, operate the compressor at a second operating speed.

6. The climate control system of claim 5, wherein the second operating speed is less than the first operating speed.

7. The climate control system of claim 1, further comprising:
a first air-moving device coupled adjacent to the first heat exchanger; and
a second air-moving device coupled adjacent to the second heat exchanger;
wherein the controller is further configured to:
adjust operation of the first air-moving device and/or the second air-moving device based on the operational data.

8. The climate control system of claim 1, wherein the climate control system is a high-capacity system, and the compressor is a high-capacity compressor.

9. The climate control system of claim 1, wherein the operating data includes one or more of a refrigerant temperature, a refrigerant pressure, a compressor speed, a compression ratio, an air-moving device speed, a refrigerant charge level, an ambient temperature, and a compartment temperature.

10. The climate control system of claim 1, wherein the controller is further configured to:
determine a refrigerant charge level based on the operational data,
in accordance with determination that the refrigerant charge level satisfies a first refrigerant charge level threshold, operate the second expansion device in the first mode, and
in accordance with determination that the refrigerant charge level satisfies a second refrigerant charge level, operate the second expansion device in the second mode.

11. The climate control system of claim 1, further comprising a receiver/drier disposed between the first heat exchanger and the second heat exchanger, the receiver/drier configured to temporarily store a refrigerant, and absorb moisture from the refrigerant.

12. The climate control system of claim 1, further comprising an accumulator disposed between the second heat exchanger and the compressor, the accumulator configured to temporarily store a refrigerant, and convert a mixed refrigerant into a gas refrigerant.

13. The climate control system of claim 1, wherein the controller is further configured to:
receive a desired temperature from an electronic device communicatively coupled with the controller, and
wherein determining the thermal load is further based on the desired temperature.

14. The climate control system of claim 1, wherein the climate control system is included in an electric vehicle.

15. A non-transitory computer readable storage medium including instructions that, when executed by a climate control system, causes the climate control system to:
obtain operational data from one or more sensors of the climate control system,
determine a thermal load based on the operational data,
in accordance with determination that the thermal load satisfies a first thermal load threshold, operate a second expansion device of the climate control system in a first mode such that the climate control system has a first refrigerant capacity, and
in accordance with determination that the thermal load satisfies a second thermal load threshold, operate the second expansion device of the climate control system in a second mode such that the climate control system has a second refrigerant capacity less than the first refrigerant capacity, wherein the climate control system comprises:
a compressor fluidically coupled with a first heat exchanger;
a first expansion device fluidically coupled with the first heat exchanger;
a second heat exchanger fluidically coupled with the first expansion device and the compressor;
the second expansion device fluidically coupled with the compressor between the first heat exchanger and the second heat exchanger, wherein the second expansion device operates as a bypass valve; and
the one or more sensors.

16. The non-transitory computer readable storage medium of claim 15, wherein the instructions further cause the climate control system to:
in accordance with determination that the thermal load satisfies a third thermal load threshold, operate the second expansion device in a third mode such that the climate control system has a third refrigerant capacity distinct from the first refrigerant capacity and the second refrigerant capacity.

17. The non-transitory computer readable storage medium of claim 15, wherein the instructions further cause the climate control system to:
in accordance with determination that the thermal load satisfies the first thermal load threshold, operate the compressor at a first operating speed, and
in accordance with determination that the thermal load satisfies the second thermal load threshold, operate the compressor at a second operating speed.

18. A method of operating a climate control system, the method comprising:
obtaining operational data from one or more sensors of the climate control system,
determining a thermal load based on the operational data,
in accordance with determination that the thermal load satisfies a first thermal load threshold, operating a second expansion device of the climate control system in a first mode such that the climate control system has a first refrigerant capacity, and
in accordance with determination that the thermal load satisfies a second thermal load threshold, operating the second expansion device of the climate control system in a second mode such that the climate control system has a second refrigerant capacity less than the first refrigerant capacity, wherein the climate control system comprises:
a compressor fluidically coupled with a first heat exchanger;
a first expansion device fluidically coupled with the first heat exchanger;
a second heat exchanger fluidically coupled with the first expansion device and the compressor;
the second expansion device fluidically coupled with the compressor between the first heat exchanger and the second heat exchanger, wherein the second expansion device operates as a bypass valve; and
the one or more sensors.

19. The method of claim 18, the method further comprising:
in accordance with determination that the thermal load satisfies a third thermal load threshold, operating the second expansion device in a third mode such that the climate control system has a third refrigerant capacity distinct from the first refrigerant capacity and the second refrigerant capacity.

20. The method of claim 18, the method further comprising:
in accordance with determination that the thermal load satisfies the first thermal load threshold, operating the compressor at a first operating speed, and
in accordance with determination that the thermal load satisfies the second thermal load threshold, operating the compressor at a second operating speed.
